(19) United States
(12) Patent Application Publication
(10) Pub. No.: US 2024/0238800 A1
(43) Pub. Date: Jul. 18, 2024

(54) APPARATUS FOR SEPARATING MATERIALS RECOVERED FROM BATTERIES

(71) Applicant: Li-Cycle Corp., Toronto (CA)

(72) Inventors: Christopher James Biederman, Hannon (CA); Timothy George Johnston, Toronto (CA); Michael Joseph Lovell, Kingston (CA); James Pettingill, Kingston (CA); Olga Misic, Etobicoke (CA)

(21) Appl. No.: 18/564,872

(22) PCT Filed: May 26, 2022
(86) PCT No.: PCT/CA2022/050855

§ 371 Date: Nov. 28, 2023

Related U.S. Application Data
(60) Provisional application No. 63/194,350, filed on May 28, 2021.
(60) Provisional application No. 63/236,009, filed on Aug. 23, 2021.

(51) Int. Cl. B03B 5/36; B03B 5/44; B29B 17/02; C22B 7/00; H01M 10/54

(52) U.S. Cl. CPC B03B 5/36; B03B 5/442; B29B 17/02; C22B 7/00; H01M 10/54; B29B 2017/0244

(57) ABSTRACT

A flotation separator apparatus can include a tank for receiving an incoming feed stream comprising plastic material and metal material liberated from battery materials. A separator liquid can be within the tank and at least a first submersion agitator may be located downstream from an inlet and may have at least a first engagement member that is movable and configured to urge the engaged metal and plastic materials downwardly to submerge them in the separator liquid thereby dislodging at least a first portion of metal material from the plastic material and allowing the dislodged first portion of the metal material to precipitate toward the lower end of the tank.

### CROSS-REFERENCE TO RELATED APPLICATIONS

This application claims priority to and the benefit of co-pending U.S. provisional application Ser. No. 63/194,350 filed on May 28, 2021 and entitled “SYSTEM AND METHOD FOR RECOVERING PLASTIC FROM BATTERY MATERIALS” and co-pending U.S. provisional application Ser. No. 63/236,009 filed on Aug. 23 2021 and entitled “APPARATUS FOR SEPARATING MATERIALS RECOVERED FROM BATTERIES”, the entirety of these applications being incorporated herein by reference.

### FIELD OF THE INVENTION

In one of its aspects, the present disclosure relates generally to a system and method for processing batteries, including lithium-ion batteries (ternary, Lithium Iron Phosphorous batteries “LFP”, lithium solid state batteries “SSB” and the like) and other suitable batteries, and more particularly to systems and methods for separating different materials, such as plastics, that have been liberated from within a battery from each other.

### INTRODUCTION

U.S. Pat. No. 9,312,581 relates to a method for recycling lithium batteries and more particularly batteries of the Li-ion type and the electrodes of such batteries. This method for recycling lithium battery electrodes and/or lithium batteries comprises the following steps: a) grinding of said electrodes and/or of said batteries, b) dissolving the organic and/or polymeric components of said electrodes and/or of said batteries in an organic solvent, c) separating the undissolved metals present in the suspension obtained in step b), d) filtering the suspension obtained in step c) through a filter press, e) recovering the solid mass retained on the filter press in step d), and suspending this solid mass in water, f) recovering the material that sedimented or coagulated in step e), resuspending this sedimented material in water and adjusting the pH of the suspension obtained to a pH below 5, preferably below 4, g) filtering the suspension obtained in step f) on a filter press, and h) separating, on the one hand, the iron by precipitation of iron phosphates, and on the other hand the lithium by precipitation of a lithium salt. The method of the invention finds application in the field of recycling of used batteries, in particular.

International Patent Application No. WO2005/101564 relates to a method for treating all types of lithium anode batteries and cells via a hydrometallurgical process at room temperature. Said method is used to treat, under safe conditions, cells and batteries including a metallic lithium anode or an anode containing lithium incorporated in an anode inclusion compound, whereby the metallic casings, the electrode contacts, the cathode metal oxides and the lithium salts can be separated and recovered.

US Patent Publication No. 2010/0230518 discloses a method of recycling sealed batteries, the batteries are shredded to form a shredded feedstock. The shredded feedstock is heated above ambient temperature and rolled to form a dried material. The dried material is screen separating into a coarse fraction and a powder fraction and the powder fraction is output. A system for recycling sealed cell batteries comprises an oven with a first conveyor extending into the oven. A rotatable tunnel extends within the oven from an output of the first conveyor. The tunnel has a spiral vane depending from its inner surface which extends along a length of the tunnel. A second conveyor is positioned below an output of the rotatable tunnel.

U.S. Pat. No. 8,858,677 discloses a valuable-substance recovery method according to the present invention includes: a solvent peeling step (S3) of dissolving a resin binder included in an electrode material by immersing crushed pieces of a lithium secondary battery into a solvent, so as to peel off the electrode material containing valuable substances from a metal foil constituting the electrode; a filtering step (S4) of filtering a suspension of the solvent, so as to separate and recover the electrode material containing the valuable substances and a carbon material; a heat treatment step (S5) of heating the recovered electrode material containing the valuable substances and the carbon material, under an oxidative atmosphere, so as to burn and remove the carbon material; and a reducing reaction step (S6) of immersing the resultant electrode material containing the valuable substances into a molten salt of lithium chloride containing metal lithium, so as to perform a reducing reaction.

PCT patent publication no. WO2018/218358 discloses a process to recover materials from rechargeable lithium-ion batteries, thus recycling them. The process involves processing the batteries into a size-reduced feed stream; and then, via a series of separation, isolation, and/or leaching steps, allows for recovery of a copper product, cobalt, nickel, and/or manganese product, and a lithium product; and, optional recovery of a ferrous product, aluminum product, graphite product, etc. An apparatus and system for carrying out size reduction of batteries under immersion conditions is also provided.

### SUMMARY

Lithium-ion rechargeable batteries are increasingly powering automotive, consumer electronic, and industrial energy storage applications. An estimated 11+ million tonnes of spent lithium-ion battery packs are expected to be discarded between 2017 and 2030, driven by application of lithium-ion batteries in electro-mobility applications such as electric vehicles.

Rechargeable lithium-ion batteries, including ternary, LFP, SSBs, and other types of batteries that may be processed using the teachings here, comprise a number of different materials within their battery cells.

A portion of the lithium-ion batteries can be described as ternary batteries, which can include lithium batteries that use lithium nickel cobalt manganate as the cathode and graphite as the anode, and batteries that use lithium-nickel-manganese-cobalt-oxide (NMC) as the cathode and graphite as the anode. Other portions of the lithium-ion batteries can include lithium iron phosphate (LFP, or sometimes as a lithium ferrophosphate battery) batteries and these batteries may have a different composition than other types of lithium-ion batteries. For example, LFP batteries utilize LiFePO₄ as a cathode material, usually in combination with a graphitic carbon-based anode. LFP batteries typically include relatively lower amounts of metals, such as nickel and cobalt, than other types of lithium-ion batteries. As nickel and cobalt can be relatively valuable, the relatively low amounts of these metals in LFP batteries may make LFP batteries less desirable to recycle than other forms of batteries that would yield relatively larger amounts of these valuable metals.

Lithium-ion batteries are a type of rechargeable battery in which lithium ions drive an electrochemical reaction. Lithium has a high electrochemical potential and a high energy density. Lithium-ion battery cells have four key components: a. Positive electrode/cathode: including differing formulations of metal oxides or metal phosphate depending on battery application and manufacturer, intercalated on a cathode backing foil/current collector (e.g. aluminum)—for example: LiNixMnyCOzO2 (NMC); LiCoO2(LCO); LiFePO4 (LFP); LiMn2O4 (LMO); LiNiCoAlO2 (NCA); b. Negative electrode/anode: generally, comprises graphite intercalated on an anode backing foil/current collector (e.g. copper); c. Electrolyte: for example, lithium hexafluorophosphate (LiPF6), lithium tetrafluoroborate (LiBF4), lithium perchlorate (LiCIO4), lithium hexafluoroarsenate monohydrate (LiAsF6), lithium trifluoromethanesulfonate (LiCF3SO3), lithium bis(bistrifluoromethanesulphonyl) (LiC₂F6NO₄S2), lithium organoborates, or lithium fluoroalkylphosphates dissolved in an organic solvent (e.g., mixtures of alkyi carbonates, e.g. Ci-C6 alkyl carbonates such as ethylene carbonate (EC, generally required as part of the mixture for sufficient negative electrode/anode passivation), ethyl methyl carbonate (EMC), dimethyl carbonate (DMC), diethyl carbonate (DEC), propylene carbonate (PC)); and d. Separator between the cathode and anode: for example, polymer or ceramic based.

“Black mass” as used herein refers to a combination of some of the components of rechargeable lithium-ion batteries or other types of batteries that can be liberated from within the cell during a processing step (such as a mechanical processing, disassembly and/or comminuting step) and includes at least a combination of cathode and/or anode electrode powders that may include lithium, nickel, cobalt, cadmium, iron, phosphorous, and manganese. Materials present in rechargeable lithium-ion batteries include the anode and cathode materials, as well as a suitable electrolyte (residual organic electrolyte such as Ci-C6 alkyl carbonates, such as ethylene carbonate (EC), ethyl methyl carbonate (EMC), dimethyl carbonate (DMC), diethyl carbonate (DEC), propylene carbonate (PC), and mixtures thereof) and possibly a solid separator which may be sulfide, oxide, ceramic or glass for SSBs. Depending on the type of batteries, or mixture of types of batteries that are being processed then the metals included in the black mass may be expected to include lithium, nickel, cadmium, cobalt, iron, phosphorous, manganese and other such materials.

Large format lithium-ion battery packs (e.g. in automotive and stationary energy storage system applications) are generally structured as follows: a. Cells: cells contain the cathode, anode, electrolyte, separator, housed in steel, aluminum, and/or plastic; b. Modules: multiple cells make up a module, typically housed in steel, aluminum, and/or plastic; and c. Battery pack: multiple modules make up a battery pack, typically housed in steel, aluminum, and/or plastic.

Several of the materials in a lithium-ion battery or battery pack can be recycled and may form separate outputs from an overall battery recycling process. For example, as noted above, PCT patent publication no. WO2018/218358 discloses a process to recover materials from rechargeable lithium-ion batteries, thus recycling them. The process involves processing the batteries into a size- reduced feed stream; and then, via a series of separation, isolation, and/or leaching steps, allows for recovery of a copper product, cobalt, nickel, and/or manganese product, and a lithium product; and, optional recovery of a ferrous product, aluminum product, graphite product, etc. An apparatus and system for carrying out size reduction of batteries under immersion conditions is also provided. However, while shredding the incoming battery materials under immersion conditions, such as described in PCT patent publication no. WO2018/218358, can have some benefits there can also be some challenges in processing the battery materials using this method.

For example, some components of the incoming battery materials, such as at least some of the plastics, packaging, insulation, connectors, fittings and the like, are less dense than the immersion liquid and therefore may tend to float within the comminuting apparatus housing. As the battery materials are comminuted (e.g. shredded in this example) the relatively heavier materials can sink toward the bottom of the comminuting housing, while the relatively lighter materials can float toward the top of the immersion liquid where they can be collected. These collected, floating materials typically include most of the plastics from the incoming battery materials and this extracted stream can be referred to as a plastic recovery stream. The material in the plastic recovery stream can provide a commercially useful output or product stream, as the collected plastic material can be sold to plastic recyclers.

Because the plastic material is floating in, and is mixed with the immersion liquid while the shredding is underway, the floating materials can be coated with, and possibly retain some portions of the immersion liquid when they are withdrawn from the comminuting housing. For example, some of the plastic pieces may have cavities, crevasses or the like which can collect liquid, and most, if not all, of the exposed surfaces of the floating, plastic materials will be wet and coated with immersion liquid, and some of the immersion liquid may flow out via the plastic material outlet port (or other analogous apparatus through with the plastic material is extracted). The immersion liquid may have entrained within it a combination of some dissolved electrolyte material and some of the black mass material or other non-plastic materials. Therefore, extracting the floating, plastic material can also lead to a loss of some of the other desirable, target materials, such as the black mass. In some examples, it is believed that about 3-7% of the black mass material that is liberated from the battery materials by the comminuting apparatus can leave with the floating, plastic materials when they are extracted.

In some known systems, including as described in PCT patent publication no. WO2018/218358, the plastic recovery stream can be washed after being withdrawn from the comminuting apparatus, and the filtrate from the washing process can be re-combined with other suitable portions of the overall recovery process. For example, the immersion liquid and any entrained black mass material that is washed from the materials in the plastics stream can be re-combined with the immersion liquid exiting the communising apparatus, or at a later stage in the process, so that any recovered black mass can be subjected to the same process steps and the original black mass. However, simply washing the plastic materials in the form they were originally extracted from the comminuting apparatus may not maximize recovery of the immersion liquid and entrained black mass, as the complex shapes of the plastic materials and surface tension of the liquids may tend to keep some of the black mass material with the plastics.

In addition to the immersion liquid and entrained black mass that can exit with the plastic materials, it has been discovered that some other components from within a battery pack may also be entangled with some of the plastic material and may then float up toward the top of the comminuting apparatus housing, rather than proceeding through the comminuting device/shredder and being properly processed. For example, it has been discovered that a battery pack that contacts the shredding apparatus (for example) can be partially shredded by its initial contact with the shredder blades, thereby separating some of the plastic housing materials from the rest of the pack, but that in some instances a battery cell, or fragments of a battery cell including non-shredded anode and cathode portions and/or other metal materials, can remain attached to the plastic housing material and can be pulled up with the plastic housing material before passing through the shredder blades. Such rogue battery cells and other metal can remain with the plastic material as it is extracted from the comminuting apparatus, and can end up mixed in with the plastic recovery stream. Having metal, battery cells and the like in the plastic recovery stream can be undesirable as it can contaminate the plastic material stream and may make it less useful for its intended purposes. It may also reduce the overall efficiency of the recycling process as the metals and battery cells in the plastic recovery stream may not further treated or captured.

Therefore, there remains a need for an improved system and/or process for isolating the plastic materials that are liberated from the battery materials during the size reduction process, such that the plastic material can be collected and sold or sent for further processing while other components of the battery materials, including metal by-products and the black mass material can be separated from the plastic for further processing.

To help address at least one of these shortcomings in the art, an improved apparatus for processing the plastic recovery stream that is extracted from the primary comminuting apparatus/process can be provided to help further separate the black mass and plastic materials. The apparatus can be configured to provide a mechanically assisted washing/separating process for the plastic recovery stream. Such a mechanical washing apparatus or tank may include one or more suitable mechanical agitators that can physically engage and/or submerge the material flowing through the mechanical washing apparatus to help mix the material in tank and dislodged attached or entrained metals and other materials. The relatively heavier metals, including the black mass materials, that are separated from the plastic materials can sink to the bottom of the mechanical washing apparatus where they can be recovered using a suitable mechanism (such as an auger or screw conveyer or the like), while the plastic material and other relatively less dense materials may remain on the top of the liquid in the tank and can be extracted separately. The liquid within the mechanical washing apparatus tank can be water, clean immersion liquid, used immersion liquid, a process liquid taken from other parts of the overall recycling process (such as a suitable buffer solution) or other suitable liquids.

In accordance with one broad aspect of the teachings described herein, a flotation separator apparatus for separating plastic material and metal material liberated from battery materials via a size reduction process may include a tank having an upper end, a lower end and an inlet for receiving an incoming feed stream including plastic material and metal material liberated from battery materials via a size reduction process. A separator liquid may be disposed within the tank and may have a liquid density that is less than a density of the metal material and greater than a density of the plastic material. At least a first submersion agitator may be located downstream from the inlet and may include at least a first engagement member disposed proximate a surface of the separator liquid and that may be movable and configured to:
engage the metal and plastic materials floating at the surface of the separator liquid at an upstream side of the first submersion agitator;
urge the engaged metal and plastic materials downwardly to submerge them in the separator liquid thereby dislodging at least a first portion of metal material from the plastic material and allowing the dislodged first portion of the metal material to precipitate toward the lower end of the tank; and
convey the plastic material downstream of the first submersion agitator whereby the plastic material will re-float toward the surface of the separator liquid;

A plastics outlet may be disposed downstream from the first submersion agitator and toward the upper end of the tank and through which a separated plastic material stream comprising at least the plastic material may be extractable from the tank. A metals outlet may be disposed toward the lower end of the tank and through which a separated metal stream comprising the precipitated metal material is extractable from the tank.

The first submersion agitator may include a body portion that is rotatable about a first rotation axis that is generally parallel to the surface of the submersion liquid, and wherein the first engagement member is movable with the body portion about the first rotation axis.

The first engagement member may include an axially extending base portion and a plurality of fingers extending laterally from the base portion. The plurality of fingers may be axially spaced apart from each other by gaps.

The fingers may have respective finger widths in the axial direction that are between about 0.5 cm and about 5 cm.

The gaps may have respective gap widths in the axial direction that are between about 0.5 cm and about 5 cm.

The first engagement member may be offset from and extends substantially parallel to the first rotation axis.

The gaps widths may be between 90% and 110% of the finger widths.

The fingers may be substantially planar and rectangular.

The first submersion agitator may also include a second engagement member that is movable with the body portion, spaced apart from and is arranged generally parallel to the first engagement member and that is configured to:
engage the metal and plastic materials floating at the surface of the separator liquid at the upstream side of the first submersion agitator;
urge the engaged metal and plastic materials downwardly to submerge them in the separator liquid thereby dislodging at least a second portion of metal material from the plastic material and allowing the dislodged second portion of the metal material to precipitate toward the lower end of the tank; and
convey the plastic material downstream of the first submersion agitator whereby the plastic material will re-float toward the surface of the separator liquid.

The apparatus may include a second submersion agitator located between the first submersion agitator and the plastics outlet. The second submersion agitator may include at least a first engagement member disposed proximate a surface of the separator liquid and that is movable and configured to:
engage the metal and plastic materials that have passed the first submersion agitator and are re-floating at the surface of the separator liquid at an upstream side of the second submersion agitator;
urge the engaged metal and plastic materials downwardly to submerge them in the separator liquid thereby dislodging at least a first portion of metal material from the plastic material and allowing the dislodged first portion of the metal material to precipitate toward the lower end of the tank; and
convey the plastic material downstream of the second submersion agitator whereby the plastic material will re-float toward the surface of the separator liquid.

The apparatus may include a third submersion agitator located between the second submersion agitator and the plastics outlet. The third submersion agitator may include at least a first engagement member disposed proximate a surface of the separator liquid and that is movable and configured to:
engage the metal and plastic materials that have passed the first and the second submersion agitator and are re-floating at the surface of the separator liquid at an upstream side of the third submersion agitator;
urge the engaged metal and plastic materials downwardly to submerge them in the separator liquid thereby dislodging at least a first portion of metal material from the plastic material and allowing the dislodged first portion of the metal material to precipitate toward the lower end of the tank; and
convey the plastic material downstream of the second submersion agitator whereby the plastic material will re-float toward the surface of the separator liquid.

The plastics outlet may include a conveyor apparatus configured to engage the plastic material at the surface of the separator liquid and convey the plastic material out of the separator liquid.

The conveyor apparatus may include at least a first inclined conveyor extending between a lower end submerged in the separator liquid and an upper end disposed above the surface of the separator liquid.

The conveyor apparatus may be configured to convey the plastic material out of the tank.

The metals outlet may include an opening in the bottom of the tank that underlies at least the first submersion agitator, through with the precipitated metal material can pass.

The apparatus may include a metals conveyor configured to receive the precipitated metal material that passed thorough the opening in the bottom of the tank and convey the precipitated metal material away from the tank.

The metals conveyor may include a submerged screw conveyor.

The separator liquid may include water and at least one of sodium hydroxide and calcium hydroxide.

The separator liquid may be at an operating temperature that is less than 70 degrees C.

### BRIEF DESCRIPTION OF THE DRAWINGS

Embodiments of the present invention will be described with reference to the accompanying drawings, wherein like reference numerals denote like parts, and in which:

FIG. 1 is one schematic example of a system for recovering plastic from battery materials,

FIGS. 2a-2d are schematic representations of one example of a separator apparatus;

FIG. 3 is a perspective view of another example of a separator apparatus, from above and to the left;

FIG. 4 is another perspective view of the separator apparatus of FIG. 3, from above and to the right;

FIG. 5 is a side elevation view of a portion of the separator apparatus of FIG. 3;

FIG. 6 is an end view of a portion of the separator apparatus of FIG. 3;

FIG. 7 is a partially exploded, perspective view of a portion of the separator apparatus of FIG. 3;

FIG. 8 is a plan view of a portion of a submersion agitator that is usable with the separator apparatus of FIG. 3; and

FIG. 9 is a partially exploded, perspective view of a portion of the separator apparatus of FIG. 3.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

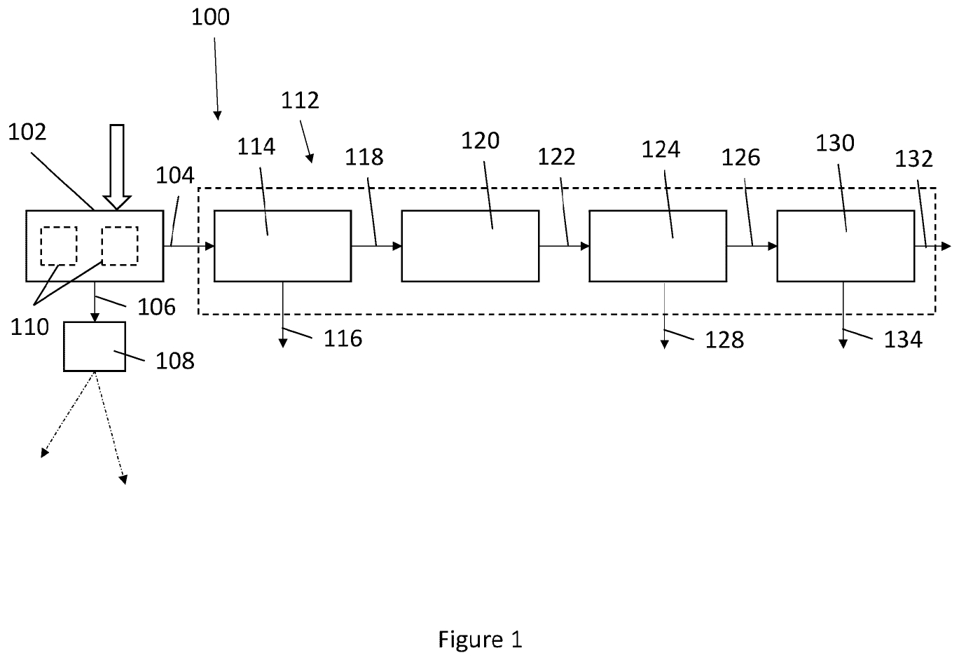

Referring to FIG. 1, one schematic representation of an example of a system 100 for recovering plastic materials from batteries is illustrated. This system 100, in the example illustrated, is configured to recover plastics from lithium-ion batteries as described herein, and may be a portion of a larger overall material recovery process that also includes upstream and downstream processing steps (including hydrometallurgical processing steps). While this system 100 and its use to primarily recover the plastic from the incoming battery materials will be described in detail as an example of the present teachings, other embodiments of the system may also be configured to recover black mass and other useful product streams, and may be used on other types of lithium batteries and other batteries that do not contain lithium.

In this example, the system 100 includes a primary size reduction apparatus 102 that is configured to receive incoming batteries and/or battery materials. One example of a suitable apparatus that can be used as part of the apparatus 102 can be described as an immersion comminuting apparatus that can include a housing that has at least one battery inlet through which battery materials can be introduced into the housing.

The size reduction apparatus 102 preferably has at least a first, submergible comminuting device that can be disposed within the housing and is preferably configured to cause a first or primary size reduction of the battery materials to form reduced-size battery materials (which can include a mixture of size-reduced plastic material, size-reduced metal material and other materials) and to help liberate metal, including lithium or other metals depending on the type of battery being processed, and cathode materials and other metals from within the battery materials.

The size reduction apparatus may include two or more separate comminuting apparatuses in some examples, and each immersion comminuting apparatus may itself have one, two or more submerged comminuting devices contained therein and arranged in series, such that the size reduction apparatus may include two or more size-reduction steps in series, and may allow for intervening process steps between the size-reduction steps. For the purposes of the teachings herein, and for distinguishing between the secondary size-reduction that is performed on the plastics slurry/stream as described herein, the overall operations of the first, or primary size reduction apparatus can be described as a first or primary size reduction process, where generally raw or unprocessed incoming battery materials can enter the size reduction apparatus 102 and then one or more streams of size-reduced material that are sent to other process steps are obtained. The content of these post-size reduction apparatus 102 material can be described has having size-reduced or primary-reduced materials (i.e. fragments of the incoming battery materials) regardless of the number of internal size-reduction steps are employed in the size reduction apparatus 102.

For example, a size reduction apparatus 102 with a single shredding stage can receive incoming battery materials, conduct at least a first size reduction and produce primary-reduced materials that are sent for further processing. Similarly. a size reduction apparatus 102 that includes two separate immersion comminuting apparatuses arranged in series (each with at least one submerged comminuting device) and with some product take-off streams between them can also be described as receiving the incoming battery materials, conducting at least a first size reduction process and producing primary-reduced materials for the purposes of the teachings herein.

The immersion material, preferably an immersion liquid (but optionally a granular solid in some examples), may be provided within the housing of the immersion comminuting apparatus and preferably is configured to submerge at least the first comminuting device, and optionally may also cover at least some of the battery materials. The first size reduction of the battery materials using this apparatus can thereby be conducted under the immersion material (and under immersion conditions) whereby the presence of oxygen is supressed, absorption of heat and the chemical treatment of electrolyte by the immersion liquid. This may also cause the electrolyte materials, the black mass material and the reduced-size plastic and metal materials to become at least partially entrained within the immersion liquid to form a blended material or slurry. Some of the size-reduced material may also float on the immersion liquid. The immersion comminuting apparatus may therefore include a plastics outlet that is positioned toward its upper end and through which a plastics slurry can be extracted, and one or more metal outlets that are provided toward the lower end of the immersion comminuting apparatus and through which a metals slurry/outlet stream can be extracted. The metals slurry/outlet stream will likely include a majority of the metal pieces and a mixture of the metallic foils, the cathode materials, electrolyte and immersion material. The plastics slurry may contain a majority of the plastic and other buoyant material, but can also include a relatively small amount of the size-reduced metal, black mass material and electrolyte materials as described herein.

The incoming battery materials can be large format batteries or small format batteries, and can include complete battery cells, battery packs and other combinations of batteries, packaging, housings and the like. Large format lithium-ion batteries can be, for example, batteries measuring from about 370 mm×about 130 mm×about 100 mm to about 5000 mm×about 2000 mm×about 1450 mm in size (or volume equivalents; expressed as a rectangular prism for simplification of geometry), and can include electric car batteries or batteries used in stationary energy storage systems. Small format batteries can be, for example, batteries measuring up to about 370 mm×about 130 mm x about 100 mm in size (or volume equivalents; expressed as a rectangular prism for simplification of geometry), and can include portable batteries such as those from cell phones, laptops, power tools or electric bicycles. Large format batteries are generally known in the art to be larger than small format batteries. In another embodiment, the battery materials can comprise battery parts as opposed to whole batteries or battery packs; however, the apparatus, system, and process described herein may be particularly suited to processing whole batteries.

The primary size reduction apparatus 102 is preferably configured so that it can produce at least two, and optionally more output streams that include different components that have been liberated from the incoming battery materials. For example, the a primary size reduction apparatus 102 is preferably configured so that plastics can be withdrawn via at least one plastic recovery stream and non-plastics, including optionally the black mass material and other materials, such as copper and aluminium foils, can be withdrawn via at least one non-plastic or metals recovery stream. This can allow the plastic material to be processed generally separately from the metal or other non-plastic materials.

The size reduction apparatus is preferably configured so that it can complete at least the first size reduction step on in the incoming battery materials under immersion conditions. That is, a size reduction apparatus can have a housing containing a least one comminuting device (e.g. a shredder) that is submerged in a suitable immersion liquid (or other suitable immersion material) while shredding the battery materials. The size reduction apparatus can be any suitable apparatus, including those described herein and those described in PCT patent publication no. WO2018/218358, U.S. Provisional Patent Application No. 63/122,757, and PCT patent application no. PCT/CA2021/050266, each of which are incorporated herein by reference.

The immersion liquid used in the described embodiments may be basic and is preferably at least electrically conductive to help absorb/dissipate any residual electric charge from the incoming battery materials. The immersion liquid may be selected such that it reacts with lithium salt (e.g. LiPF₆) that may be produced via the liberation of the electrolyte materials during the size reduction process, whereby the evolution of hydrogen fluoride during the size reduction is inhibited. The immersion liquid within the housing of the primary immersion apparatus 102 may preferably be at an operating temperature that is less than 70 degrees Celsius to inhibit chemical reactions between the electrolyte materials and the immersion liquid, and optionally the operating temperature may be less than 60 degrees Celsius. The immersion comminuting apparatus can be configured so that the immersion liquid is at substantially atmospheric pressure (i.e. less than about 1.5 bar) when the system is in use, which can simplify the design and operation of the apparatus.

In some examples, the immersion liquid may be at least one of water and an aqueous solution. The immersion liquid may have a pH that is greater than or equal to 8, and optionally may include at least one of sodium hydroxide, calcium hydroxide, and lithium hydroxide. The immersion liquid may include a salt, whereby the immersion liquid is electrically conductive to help at least partially dissipate a residual electrical charge within the battery materials that is released during the size reduction. The salt may include at least one of sodium hydroxide, calcium hydroxide and lithium hydroxide.

Particles that are liberated from the battery materials by the comminuting apparatus 102 during the first size reduction may be captured and entrained within the immersion liquid and may be inhibited from escaping the housing into the surrounding atmosphere. The first comminuting device may be configured as a shredder that is configured to cause size reduction of the battery materials by at least one of compression and shearing. The black mass material obtained using these processes, including at least some residual amounts of the immersion liquid and any electrolytes entrained therein can form the black mass feed materials as described herein.

In the illustrated example, the primary size reduction apparatus 102 is configured so that it can carry out a first size reduction and shred the incoming battery materials via at least one shredding/comminuting device submerged in a suitable immersion liquid, whereby plastics and other relatively light materials will float in the immersion liquid and metals and other relatively heavy materials will tend to sink. The plastic materials can be skimmed or otherwise extracted as a plastics slurry from the shredding/comminuting device via a plastic recovery stream 104. As noted above, the plastics slurry in the plastic recovery stream can include a combination of size-reduced plastic material along with some of the immersion liquid and some metals (including black mass and/or copper and aluminum foils) that are entrained with the liquid and/or stuck to or within the plastic pieces. The materials as shredded via this first comminuting apparatus 102 can also be described as primary-reduced metal material, primary-reduced plastic material herein.

The primary sized-reduced battery materials can form a metals outlet stream 106 that exits the primary size reduction apparatus 102, and can include a majority of the black mass materials liberated in the primary size reduction apparatus 102 and/or copper and aluminum foils that have been separated from the plastics. For example, the metals slurry exiting via the metals outlet stream 106 may include at least 60%, 70%, 80%, 90%, 95% wt. or more of the liberated black mass materials, which may be advantageous if the metals outlet stream 106 is to be sent for further processing to separate the metals and preferably recover at least some of the lithium from the black mass.

For example, the metals outlet stream 106 exiting the primary disassembly apparatus 102 can optionally be sent through a hydrometallurgical processing system 108 (or any other suitable processing system) that can be used to help separate lithium metal from foils and other cathode material that is present in the size-reduced battery materials, as well as extract other desired product streams and materials (illustrated using dashed arrows in FIG. 1). The hydrometallurgical processing system 108 can include any suitable processes and systems, including leaching, precipitation, filters and other operations that can help separate and extract the various target products, including utilizing the processes and systems described in in PCT patent publication no. WO2018/218358, U.S. Provisional Patent Application No. 63/122,757, U.S. Provisional Patent Application No. 63/230,895 and PCT patent application no. PCT/CA2021/050266, each of which are incorporated herein by reference.

Conversely, a relatively smaller, minority amount of the liberated black mass material, such as less than 15%, or less than about 10%, 9%, 8%, 7%, 6%, 5%, 4%, 3%, 2% or 1% wt. of the expected/liberated black mass material may be captured in the plastics slurry. As this black mass material that escapes via the plastics slurry may be commercially valuable, it may be advantageous to recover at least some of the black mass material that escapes the primary comminuting apparatus 102 via the plastics slurry.

The size reduction apparatus 102 may have any suitable configuration and may include one, two or more physical/mechanical processing steps (in two or more separate apparatuses or physical structures shown schematically as sub-apparatuses 110 in FIG. 1) that can be help convert the incoming battery materials to a suitable size-reduced battery materials that can then form at least part of the blended metals material stream 106 that exits the size reduction apparatus 102 for further processing. For example, the size reduction apparatus 102 may include one or more suitable comminuting apparatus that can grind/shred the battery materials, thereby liberating materials from within the battery cells and reducing the physical size of the battery materials. A single stage comminuting apparatus may be configured so that the battery materials only pass through one comminuting device 110 before exiting the apparatus 102, although there may be several comminuting devices arranged in parallel within a single housing/apparatus or in separating housings/apparatuses to accommodate a desired volume of incoming battery materials. Alternatively, the apparatus 102 may include two or more comminuting devices 110 arranged in series, such that the incoming battery materials undergo at least two, and optionally more, size reduction processes in series. It is also possible that in some examples of the systems and processes described herein that other materials could be added as part of the disassembly processes and one or more chemical or physical reactions could also occur within the apparatus 102.

Whether a single or multiple processing steps are used within the apparatus 102, and/or whether any other processes or reactions occur, the metal materials exiting the apparatus 102 via stream 106 can be further processed via the hydrometallurgical processing system 108 and the plastics slurry extracted via the plastic recovery stream 104 can be described as the primary plastics slurry that is understood to include both plastic material pieces as well as the mixture of immersion liquid, black mass material and other inadvertently captured metals and cells as used herein.

After leaving the size reduction apparatus 102, the plastics slurry in the plastic recovery stream 104 can be processed via a plastic recovery circuit 112 that can include multiple sub-steps and assemblies, as illustrated schematically in FIG. 1. In this example, the plastic recovery circuit 112 receives the plastics slurry in the plastic recovery stream 104 exiting the size reduction apparatus 102 and directs the plastic recovery stream 104 to a pre-wash apparatus 114, which can include any suitable solid/liquid separator device such as a screen, where the material in the plastic recovery stream 104 can be sprayed with a suitable liquid, such as used or unused immersion liquid, water or other solutions, so that at least some of the black mass, immersion liquid and entrained electrolyte material can be washed off of the larger plastic pieces, and other material pieces in the primary plastics slurry.

This first washing process will generally not be sufficient to dislodge or separate large metal material pieces from the plastics slurry, such as intact or partially intact battery cells that are mixed in the plastic recovery stream 104 because such material may be about the same size as the plastic pieces and/or may be connected to a plastic piece such that they will not pass through the screen. The filtrate 116 from the a pre-wash apparatus 114 can be discarded, sent for further processing and/or recycled upstream into the process (such as being re-introduced into the size reduction apparatus 102). The remaining solid plastic and metal material in the plastics slurry can exit the pre-wash apparatus 114 as a washed stream 118. The pre-wash apparatus 114 is optional, and can be omitted in some examples of the plastic recovery circuit 112.

In the illustrated example, the washed plastics slurry stream 118 (or the untreated plastics slurry in embodiments that do not include the pre-wash apparatus 114) is then directed to a suitable plastic comminuting apparatus 120 that is configured to conduct a subsequent, second size-reduction on the incoming mixed plastic and metal material in the plastics slurry. This second size-reduction step is optional and need not be included in all examples of the systems and processes described herein.

The plastic comminuting apparatus 120 can include a respective housing and any suitable, secondary comminuting device (or multiple comminuting devices) that can break the relatively large pieces in the incoming plastics slurry into smaller pieces, and can include a dual or quad-shaft shredding device having a pair(s) of contra-rotating, intermeshing shredding rollers with suitable blades to cause the desired size reduction in the battery materials, or other suitable device, that can shred the plastic slurry using primarily shear forces. The plastic comminuting apparatus 120 can have a housing that contains the shredding rollers, has an inlet to receive the plastic slurry and at least one outlet via which a size-reduced plastic slurry (e.g. a plastic slurry in which the plastic and metal pieces have been subjected to a further size reduction and are smaller than in the plastic slurry exiting the primary comminuting apparatus 102) can be extracted.

Unlike the primary comminuting apparatus 102, the plastic comminuting apparatus 120 is preferably configured as a non-immersion comminuting apparatus in which its shredding blades (or other suitable comminuting device) are not submerged in an immersion liquid when in use. This may be helpful because the process stream that is being sent to the plastic, non-immersion comminuting apparatus 120 includes materials that were generally buoyant in the immersion liquid contained in the primary comminuting apparatus 102 to a degree that they did not pass all the way through the comminuting device and were skimmed from the upper portion/surface of the immersion liquid. If this comminuting device were also submerged in the same immersion liquid then it is likely that at least some of the incoming materials would again float on the liquid, and may not be properly processed by this comminuting device. Therefore, the plastic comminuting apparatus 120 is configured as a non-immersion comminuting apparatus where the incoming, relatively buoyant materials will not float away from the shredding cutters.

If desired, the plastic comminuting apparatus 120 can include a spraying apparatus that can spray a suitable spray liquid onto the shredding blades of the non-immersion comminuting device and/or incoming material while the apparatus 120 is in use (to help reduce dust, dissipate heat, inhibit of-gassing etc.). The spray liquid can include used or unused immersion liquid, water or other suitable liquids.

Processing the plastic slurry via the plastic comminuting apparatus can produce a size-reduced, secondary plastic slurry 122 that can be extracted from the apparatus 120. In addition to relatively smaller plastic and metal pieces, the size-reduced plastic slurry may also include electrolyte, black mass materials that was separated from the plastic and metal pieces via the shredding and may also include a second amount of newly released electrolyte, black mass materials that is first liberated when any partially or completely intact battery cells were ruptured by the plastic comminuting apparatus 120 (i.e. having not been ruptured via the primary comminuting apparatus 102).

Having been processed through the plastic comminuting apparatus 120, the size-reduced, secondary plastic slurry 122 and can be further processed to help separate the smaller plastic pieces from the metal pieces, black mass and electrolyte materials that are mixed within the sized-reduced plastic slurry 122. This post-second-size-reduction separation can be done using any suitable separator 124 that is downstream from and fluidly connected to the plastic comminuting apparatus 120. The separator 124 can be any suitable device that is operable to help separate the size-reduced plastic pieces from the size-reduced metal pieces, black mass and electrolyte, including those described herein.

Preferably, the separator 124 can include a separator tank that can receive the size-reduced plastic slurry. The separator tank can hold a suitable liquid, such as the immersion liquid (used or unused), water, the spray liquid used to spray the interior of the plastic comminuting apparatus 120 or other suitable composition. As the size-reduced plastic slurry enters the separator tank heavy material, like the metal pieces and black mass may tend to sink while the lighter plastic may remain on the surface. Optionally, the separator tank can include one or more mechanical agitators positioned to engage the material floating near or on the surface of the liquid within the separator tank to agitate and preferably temporarily re-submerge the floating material, for example as it travels along the tank. This may help dislodge any embedded metal material and/or to help wash off any adhering black mass and/or electrolyte materials from the plastic in the secondary plastic slurry. The separator tank can optionally include two or more such mechanical agitators arranged in series. The two or mechanical agitators may be generally identical to each other, or may have different configurations.

The separator 124 is preferably configured to have a plastics outlet toward the top of the tank where a relatively purer stream of separated plastic material 126 can be extracted, and a metals outlet toward the bottom of the tank through which any of the separated, precipitated metals and other non-plastic materials can be extracted as a metals stream 128. The metals stream 128 may be subjected to any desired processing to help recover any target metals and/or black mass material that was separate from the size-reduced plastic slurry via the separator 124 and may be routed into the hydrometallurgical process 108 or other suitable process.

Optionally, the separator 124 may also include any other suitable device(s), such as a filter, precipitation tank, screen, magnetic separator or the like.

Optionally, the separated plastic material 126 exiting the separator 124 can be subjected to a second washing/screening process using a post-wash apparatus 130, that can be any suitable apparatus and may be generally the same as, or different than, the pre-wash apparatus 114. In this example, the post-wash apparatus 130 can include a screen where the separated plastic material 126 can be sprayed with a suitable liquid to help remove remaining black mass, electrolyte or other material that may have remained on the separated plastic material 126 when it exited the separator 124. The output plastic material 132 exiting the post-wash apparatus 130 can then exit the plastic circuit 112 and be collected and packaged for sale or further processing. If a post-washing apparatus 130 is not used, the separated plastic material 126 may also serve as the output plastic material 132. The filtrate from the post-wash apparatus 130 can exit as filtrate stream 134, and can be disposed of, further processed and/or recycled into the processes described herein.

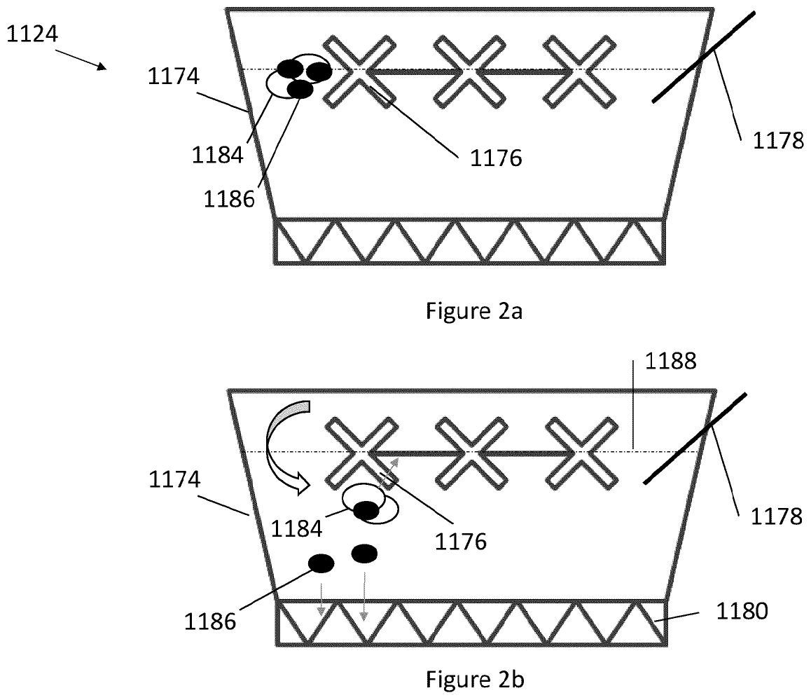

Referring also to FIGS. 2a and 2b, one schematic illustration of a separator apparatus 1124 that can be configured to be the separator 124 as described above, is illustrated. In this example, the separator 1124 is configured to be positioned downstream from the plastic comminuting apparatus 120 to help separate the smaller plastic pieces from the metal pieces, black mass and electrolyte materials that are mixed within the sized-reduced plastic slurry 122. In this example, the separator 1124 includes a separator tank 1174 that can receive the size-reduced plastic slurry 1122. The separator tank 1174 can hold a suitable separator liquid that can include water, an aqueous solution, the immersion liquid, the liquid used to spray the interior of the plastic comminuting apparatus 1120, a mixture of such liquids or other suitable composition. At least some of the separator liquid that leaves the tank 1174 can be recycled upstream in the process (such as via being recirculated into the size reduction apparatus 102). Optionally, the liquid that is initially provided in the separator tank 1172 or that is added into the tank 1172 while the system is in use can be “fresh” immersion liquid (liquid that is generally the same as the liquid within the size reduction apparatus 102 but that has not actually been run through the size reduction apparatus 102) or can be immersion liquid that has flowed through the size reduction apparatus 102 and is carrying the plastics and other materials with it, or a mixture of such liquids. As the operation of the apparatus 1124 generally operates via mechanical agitation and floatation/settling process the composition and chemical attributes of the separator liquid may not materially alter the operation of the apparatus 1124 in some examples.

As the size-reduced plastic slurry enters the separator tank 1174 heavy material, like the metal pieces, may tend to sink while the lighter plastic may remain on the surface. In this example, the separator tank 1174 is shown schematically with three mechanical agitators in the form of rotatable submersion baffles or agitators 1176 that are positioned to engage the material floating on the surface of the liquid within the separator tank 1174 to agitate and optionally re-submerge the floating material as it travels along the tank 1174. This may help dislodge embedded metal material and/or to help wash off any adhering black mass and/or electrolyte materials. For example, referring also to FIGS. 2a and 2b, the secondary plastic slurry can include a mixed combination of plastic pieces 1184 and metal pieces 1186, which when mixed may float along the surface 1188 of the liquid within the tank 1174. The agitators 1176 are positioned at about the surface level of the liquid so that the baffles 1176 can mechanically impact and engage the pieces 1184 and 1186, which may help separate them. Also, the rotation of the agitators 1176 in this example (counter-clockwise as illustrated between FIGS. 2c and 2d) can drive the pieces 1184 and 1186 under the surface of the liquid. In this configuration, gravity may tend to pull the relatively dense metal pieces 1186 down toward the bottom of the tank for extraction, while the buoyancy forces acting on the plastic pieces 1184 may urge them back toward the surface 1188. While shown as rotatable members, in other examples the agitators may be moveable but need not be rotatable, and may pivot, translate, oscillate or otherwise move to help engage the materials in the tank.

The separator 1124 includes a conveyor 1178 at its downstream end that can help remove the floating plastic material from the surface of the liquid in the tank 1174, thereby providing the relatively purer/cleaner stream of separated plastic material 1126. A metals outlet is provided toward the bottom of the tank 1174 and includes a screw conveyor 1180 that can receive the separated metals and other non-plastic materials to provide the metals stream 1128. The metals stream 1128 may be subjected to any desired processing to help recover any target metals and/or black mass material that was separate from the size-reduced plastic slurry via the separator 1124.

Optionally, the separated plastic material and recovered metal pieces exiting the separator 1124 can be subjected to any suitable downstream processing, including additional washing/screening process using a post-wash apparatus, drying, packaging, bagging, further separation and the like.

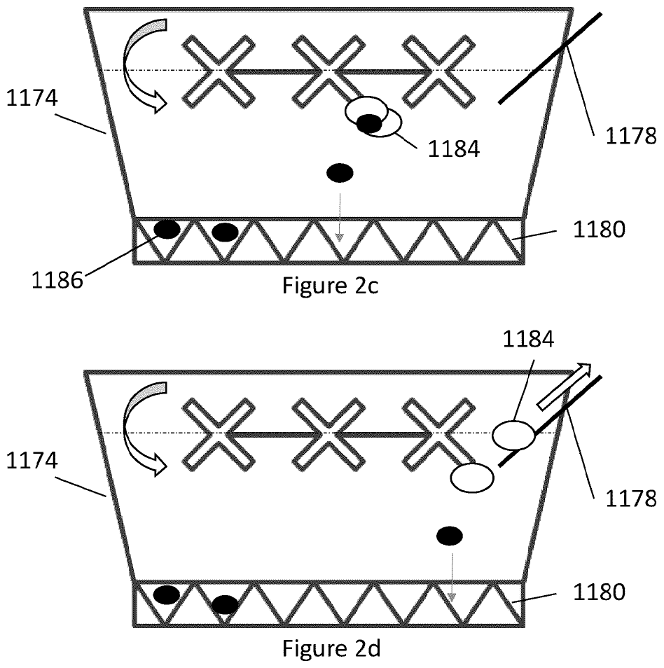

Referring to FIGS. 3 to 5, another example of a separator 2124, that can be used as the separator 124 described herein, is illustrated. The separator 2124 can include features that are analogous to those schematically illustrated in separator 1124, with like features annotated using like reference characters indexed by 1000.

In this example, the separator 2124 includes a separator tank 2174 that can receive the size-reduced plastic slurry at its inlet end 2200 as described herein. While the tank 2174 is shown empty in these drawings for clarity, the interior of the tank 2174 can be filled with a suitable liquid when the tank 2174 is in use. Material that is introduced into the tank 2174 can then float on the liquid from the inlet end 2200, along a travel or flow direction 2202, to an opposing outlet end 2204 where the plastic and other floating material can be extracted and optionally sent for further processing.

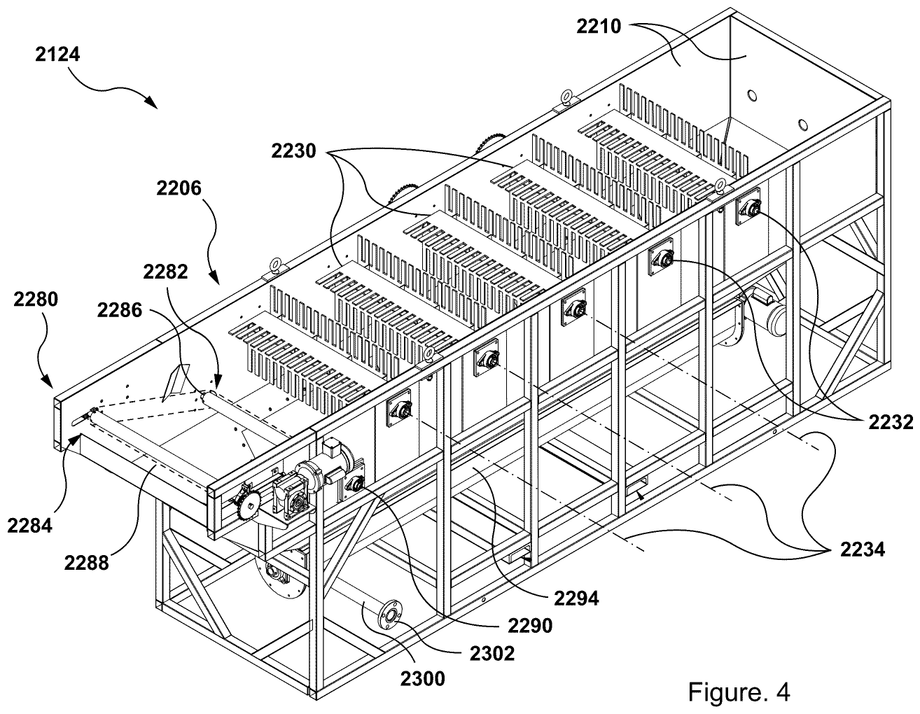

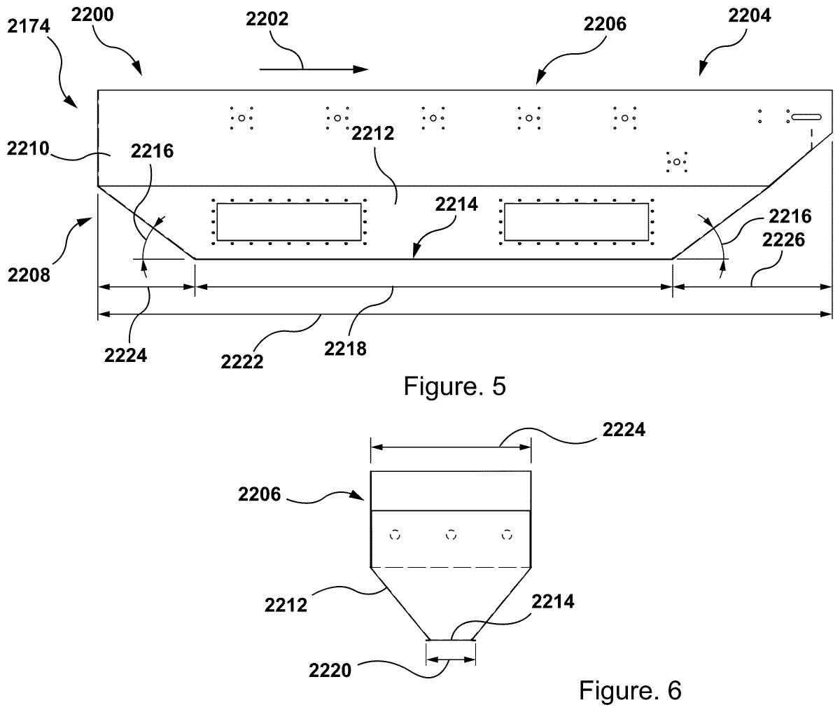

Referring also to FIGS. 5 and 6, in this example the tank 2174 has an open upper end 2206 tappers toward its lower end 2208. This may help precipitated material to collected in a desired region at the lower end 2208 for collection and processing. The specific configuration of the walls of the 2174 may differ in different example, but in the illustrated example, the upper portion of the tank includes generally vertical sidewalls 2210 that extend from the upper end 2206 to connected, tapering lower sidewalls 2212 that extend to a lower end wall 2214.

The lower sidewalls 2212 may be inclined at any suitable angle 2216 that can help promote the movement/settling of precipitated material toward the lower end 2208. The sidewall angle 2216 as illustrated may be between about 15 and 75 degrees, and preferably may be between about 20 and about 60 degrees, and may be between about 30 and 45 degrees in some examples.

In this arrangement, the lower end wall 2214 defines a lower end length 2218 (in the flow direction 2202) and a lower end width 2220, that are each less than the corresponding upper end length 2222 and upper end width 2224. A front or inlet zone that is defined by a region at the inlet end 2200 that is underlied by an portion of the inclined sidewall 2212 can have a zone length 2224 (FIG. 5), while a corresponding outlet zone can have a zone length 2226, that can optionally be longer than the zone length 2224. This may help provide space in the outlet zone to accommodate a weir, conveyor or other such material removal apparatus. In this arrangement, the open, upper region of the inlet zone can provide at least part of the inlet through which an incoming feed stream can be introduced into the tank 2174. While the upper portion of the tank 2174 is uncovered in the illustrated example, it may be at least partially covered or otherwise enclosed to help prevent contamination from entering the tank 2174 and/or to help reduce the evaporation or other loss of the liquid in the tank 2174.

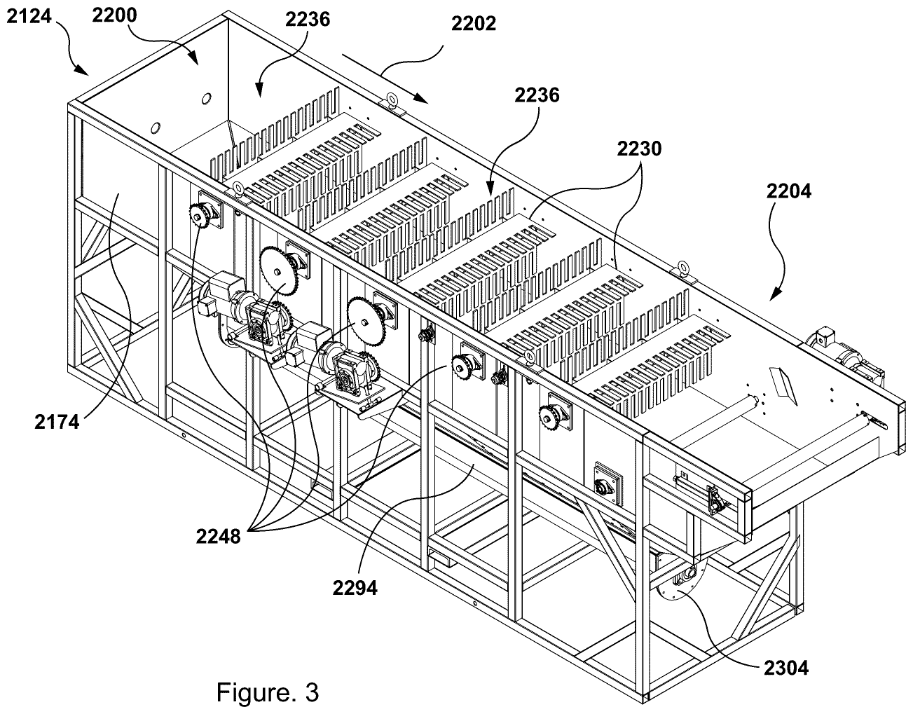

Referring again to FIGS. 3 and 4, in this example the apparatus 2124 also includes a plurality of submersion agitators 2230 that are connected toward the upper end 2206 of the tank 2174 and are axially spaced apart from each other in the direction of flow 2202. The agitators 2230 are rotatably connected to the sidewalls 2210 using suitable bearing assemblies 2232 and are each rotatable about respective rotation axes 2234. Each agitator 2230 is configured so that it is proximate the level of the free surface of the liquid within the tank 2174 (and the liquid level is preferably maintained at fairly steady working level while the system is in use) so that they can engage the metal and plastic materials floating at the surface of the separator liquid at their respective upstream side 2236. The agitators 2230 are then rotated, using a suitable driving apparatus, to urge the engaged metal and plastic materials generally downwardly under the agitator to submerge the materials in the separator liquid thereby dislodging at least a first portion of metal material from the plastic material and allowing the dislodged first portion of the metal material to precipitate toward the lower end of the tank. The materials submerged in this manner by a given agitator 2230 will also be conveyed in a generally forward (as per the flow direction 2202) direction such that the materials will pass under a given agitator 2230 which can help convey the plastic material downstream of a given agitator 2230 and travel downstream within the tank 2174 until the plastic material will re-float toward the surface of the separator liquid and travel to the next agitator 2230 in series or the outlet. The agitators 2230 used in this tank 2174 may be of any suitable design that can engage and submerge the material in the incoming feed stream.

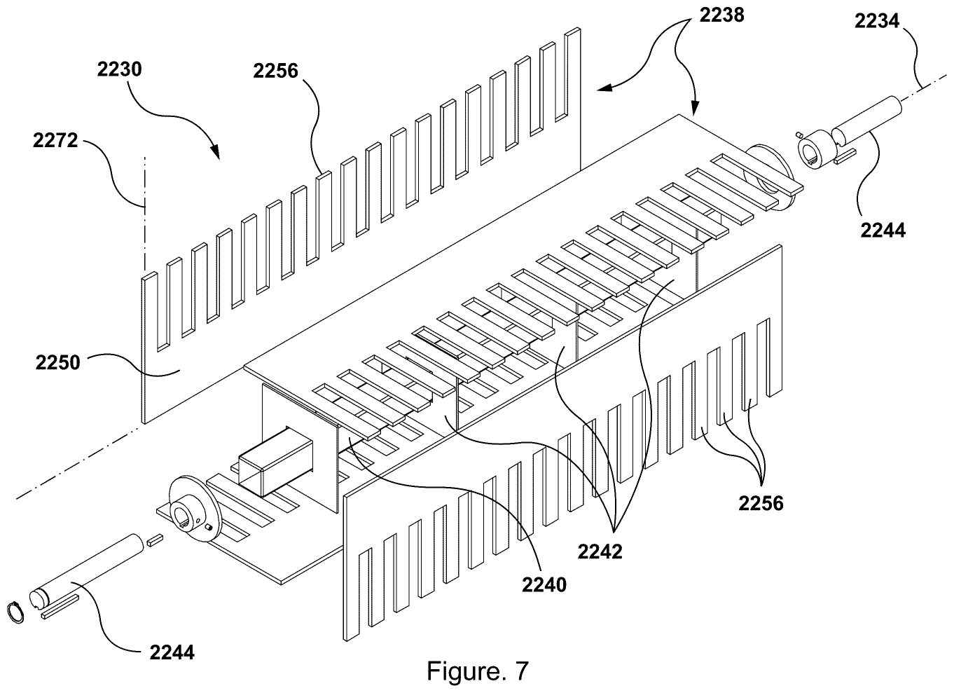

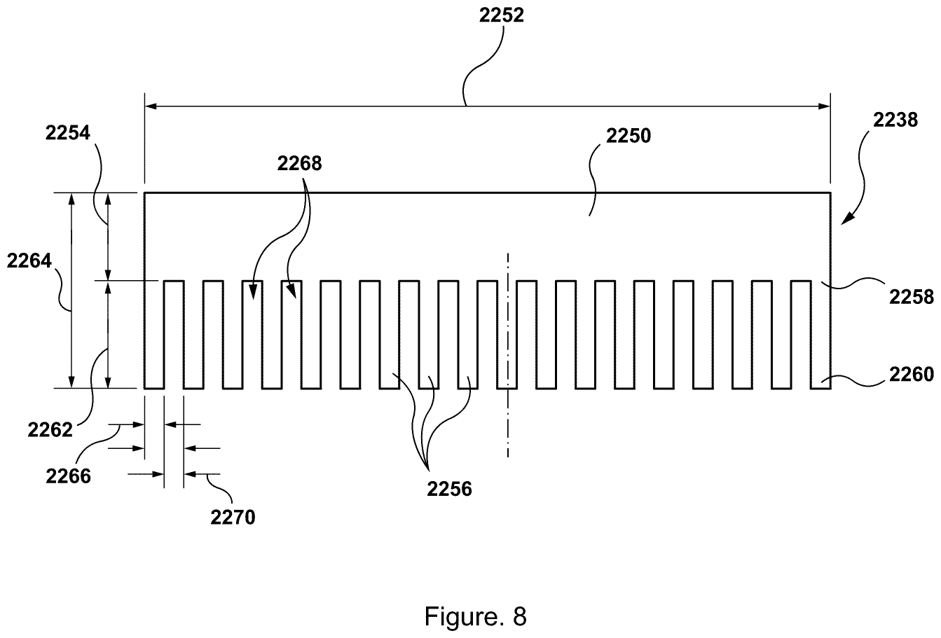

Referring also to FIGS. 7 and 8, in the illustrated example each agitator 2230 includes four engagement members, in the form of rakes 2238, that are connected to a common body portion that includes a rotatable axel 2240 and mounting plates 2242, but other attachment options are possible in other examples. In this example, the axel 2240 extends along and defines the axis of rotation 2234 for the given agitator 2230. The ends of the axel 2240 can be connected to their associated bearings using any suitable mechanism, including bolts, pins and other fasteners, and in this example utilize mounting pins 2244.

The rakes 2238 may have different configurations in different examples, but in the illustrated example each rake 2238 includes a body portion 2250 that is connected to and rotatable with its axel 2240. The body portion 2250 in this example is a generally plate-like member that has a width 2252 in the axial direction (e.g. parallel to the rotation axis 2234) and a length 2254 that is orthogonal to the width 2252. The width 2252 can be any suitable width that is compatible with a given tank 2174, and may be between about 15 cm and about 200 cm, or more in some examples, and preferably may be between about 20 cm and about 50 cm. The length 2254 may be any desired length that provides a body portion 2250 having a desired size and strength for a given application, and may be between about 10% and about 30% of the width 2252 in some examples, and may be between about 2 cm and about 10 cm or more, and may be between 4 cm and 5 cm.

Each rake 2238 also includes a plurality fingers 2256 that extend along respective finger axes 2262 from respective roots 2258 (proximate the body portion 2250) to free tips 2260, and define a finger length 2262 that is sized to engage the expected incoming plastic material, and optionally may be longer than the base length 2254. For example, the finger length 2262 may be between about 4 cm and about 8 cm or more, and may be between 5 cm and 6 cm in the illustrated example. In these examples, the overall rake length 2264 (the sum of 2254 and 2262) may be between about 5 cm and about 15 cm or more, and may be about 10 cm in some examples.

Each finger 2256 also has a finger width 2266 that can be between 0.5 cm and 5 cm (or more in some examples) and is preferably spaced apart from the adjacent fingers 2256 by gaps 2268 that have respective gap widths 2270. The gap widths 2270 may be the same as the finger widths 2266, or may be different but preferably between about 50% and 150% of the finger widths 2266, and preferably may be between about 90% and about 110% of the widths 2266. Providing gaps 2268 between the fingers 2256 may help the fingers 2256 grasp/engage the material that is floating on the surface of the liquid in the tank 2174, and may also allow the fingers 2256 to pass more easily through the liquid (for example as compared to using a solid plate instead of separate fingers).

While shown as being generally linear and having a constant width along the length 2262 in this example, in other examples the fingers 2256 need not be linear and need not have a constant shape. They may have other shapes and configurations, such as curved, angled or wavy profiles and need not have a constant width 2270 along their length 2262.

In the illustrated example, the rakes 2238 are configured as generally flat, planar members that lie in respective rake planes (see plane 2272 in FIG. 7). When assembled for use in the tank 2174, the agitators 2230 are configured with the rakes 2238 mounted to the axel 2240 such that they are parallel to, but offset from the rotation axis 2234 (i.e. plane 2272 is parallel to but spaced from axis 2234, for example).

To drive the agitators 2230, the apparatus can include any suitable driving or actuating mechanism. In the illustrated example, sprockets 2248 can be connected to each axel 2240 and can be engaged and driven by a suitable drive chain (not illustrated for clarity), which can be driven by an electric motor or other suitable drive unit. Preferably, a common drive chain can be used to engage at least some, and optionally all of the sprockets 2248 so that the agitators 2230 can be driven in union with each other.

In this example, the axes of rotation 2234 of the agitators 2230 were arranged to be generally parallel to each other and to the surface of the liquid within the tank 2174 and to be substantially orthogonal to the flow direction 2202. This may help provide generally consistent agitating across the width of the tank 2174 at a desired elevation. In other examples, the axes 2234 may have different orientations.

Referring again to FIG. 4, as the floating material is engaged by and passes by/under each agitator 2230 it will be successively dunked/submerged in the liquid as it passed under each agitator 2230 and will then at least partially re-float prior to engaging the next agitator 2230, which may help dislodge the metal and other non-buoyant materials. Plastics and other materials that are buoyant in the liquid contained in the tank 2174 can then reach the outlet end 2204 of the tank 2174 while still being at or close to the surface of the liquid. These materials can then engage by any suitable recovery apparatus, such as a conveyor apparatus or skimmer that can collect the floating material and convey it out of the tank 2174. In this example, the apparatus 2124 includes an inclined conveyor apparatus 2280 that extends between an inboard, lower end 2282 and an outboard, upper end 2284. The lower end 2282, in this example, is intended to be submerged within the liquid when the apparatus 2124 is in use and includes a lower roller 2286, while the upper end includes an upper roller 2288 that is disposed above the liquid. A suitable conveyor belt can extend between the rollers 2286 and 2288 and is shown in phantom lines in FIG. 4 for clarity. A conveyor drive apparatus, including an electric motor 2290 and associated drive sprockets and chains, is provided to drive the conveyor belt when needed. This motor 2290 may be manually controlled and/or may be operated by a suitable system controller, such as a computer, PLC or the like. Optionally, the speed of the conveyor apparatus may be matched to the rotating speed of the agitators 2230.

In addition to the plastics and buoyant material outlet, the tank 2174 can include one more metal outlets and/or precipitate outlets that are configured to remove material from below the surface of the liquid in the tank 2174. While referred to as metal outlets for convenience, and because most of the recovered material that sinks into the liquid will be metal, these outlets may also receive and convey any other relatively dense, non-buoyant material that was received in the incoming feed stream, such as relatively dense plastic and the like. Preferably, the metals outlet can include one or more openings or holes in the lower portions of the tank 2174 through which the precipitated metals, along with some of the separator liquid, can exit the interior of the tank 2174 and can be collected by a suitable collection and conveyance apparatus. Make-up liquid can be added to the tank 2174 as desired to help balance any outflow of liquid via the metals outlet so that the overall level of the liquid within the tank 2174 can be kept at the desired operating level. Optionally, one or more of the opens that forms part of the metals outlet can be registered below the agitators 2230 so that dislodged heavy material will fall more or less directly into the metals outlet. This may reduce the need to provide conveyors within the lower portion of the tank 2174 to help urge the precipitated material toward the metals outlet. Similar, the inclined lower sidewalls 2212 can be arranged to terminate at or near the opening(s) that are part of the metals outlet so the tank 2174 does not have many, if any, flat bottom surfaces on which precipitated material will collect.

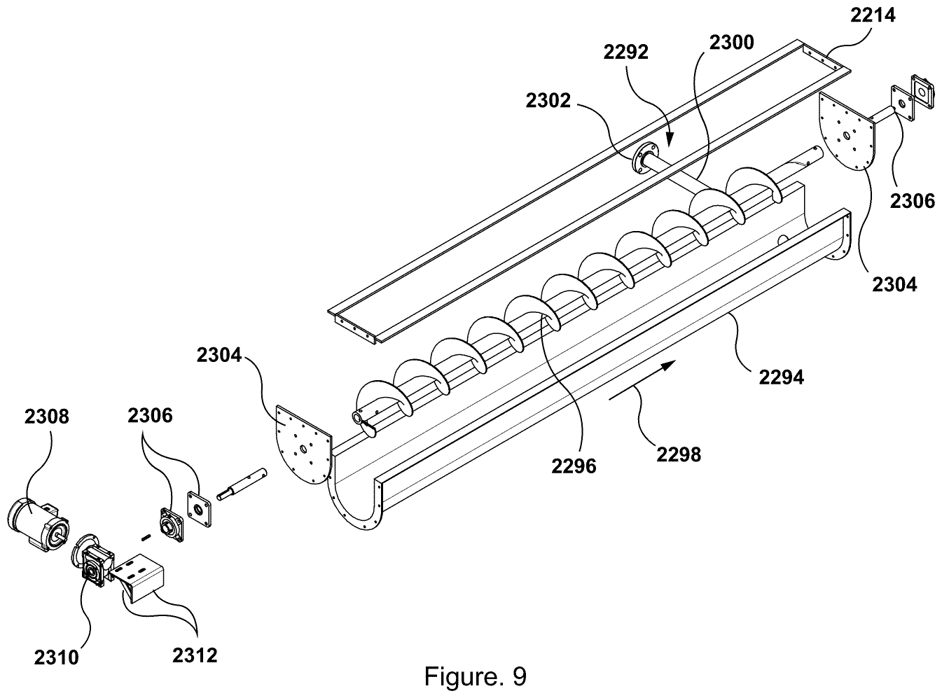

Referring also to FIG. 9, in the illustrated example, the metals outlet includes an opening 2292 in the bottom wall 2214 of the tank 2174 that occupies almost all of the area of the bottom wall 2214. This opening 2292 extends almost all of the length 2218 of the bottom wall 2214 and underlies all of the agitators 2230 that are supported by the tank 2174. Metal and other debris that is separated from the floating plastics and buoyant material will tend to fall into and through the opening 2292 as the apparatus 2124 is in use, and can be collected within a metal conveyor housing 2294 that is connected to the lower end of the tank 2174.

The metal conveyor housing 2294 is configured to contain a conveying apparatus, in the form of a screw conveyor 2296 that can urge received material in a conveyance direction 2298 toward an outlet conduit 2300 that terminates in a flange 2302. End caps 2304 can help enclose the housing 2294, and bearing units 2306 can be used to rotatably support the screw conveyor 2296. A drive unit, including motor 2308, transmission unit 2310 and mounting brackets 2312, can be provided to drive the screw conveyor.

Materials that are collected via the metals outlet, and conveyed through conduit 2300 can be sent for further processing, including drying and/or separation operations to separate the metal and other solid material from the separator liquid. The liquid can be reclaimed and may be reused, such as by recycling the liquid into the tank 2174.

The separator liquid used in the described embodiments may be basic and is preferably at least electrically conductive to help absorb/dissipate any residual electric charge from the incoming battery materials. The separator liquid within the tank 1174 may preferably be at an operating temperature that is less than 70 degrees Celsius to inhibit chemical reactions between the electrolyte materials and the immersion liquid, and optionally the operating temperature may be less than 60 degrees Celsius.

The separators described herein can be configured so that the separator liquid is at substantially atmospheric pressure (i.e. less than about 1.5 bar) when the system is in use, which can simplify the design and operation of the apparatus 1124.

In some examples, the separator liquid may be at least one of water and an aqueous solution. The separator liquid may have a pH that is greater than or equal to 8, and optionally may include at least one of sodium hydroxide, calcium hydroxide, and lithium hydroxide. The separator liquid may include a salt and the salt may include at least one of sodium hydroxide, calcium hydroxide and lithium hydroxide.

For the purposes of describing operating ranges and other such parameters herein the phrase “about” means a difference from the stated values or ranges that does not make a material difference in the operation of the systems and processes described herein, including differences that would be understood a person of skill in the relevant art as not having a material impact on the present teachings. For lengths and sizes “about” may, in some examples, mean plus or minus 10% of the stated value but is not limited to exactly 10% or less in all situations.

All publications, patents, and patent applications referred to herein are incorporated by reference in their entirety to the same extent as if each individual publication, patent, or patent application was specifically and individually indicated to be incorporated by reference in its entirety. It is understood that the teachings of the present application are exemplary embodiments and that other embodiments may vary from those described. Such variations are not to be regarded as a departure from the spirit and scope of the teachings and may be included within the scope of the following claims.

We claim:

1. A flotation separator apparatus for separating plastic material and metal material liberated from battery materials via a size reduction process, the apparatus comprising:
a) a tank having an upper end, a lower end and an inlet for receiving an incoming feed stream comprising plastic material and metal material liberated from battery materials via a size reduction process;
b) a separator liquid disposed within the tank and having a liquid density that is less than a density of the metal material and greater than a density of the plastic material; and
c) at least a first submersion agitator located downstream from the inlet and comprising at least a first engagement member disposed proximate a surface of the separator liquid and that is movable and configured to:
i. engage the metal and plastic materials floating at the surface of the separator liquid at an upstream side of the first submersion agitator;
ii. urge the engaged metal and plastic materials downwardly to submerge them in the separator liquid thereby dislodging at least a first portion of metal material from the plastic material and allowing the dislodged first portion of the metal material to precipitate toward the lower end of the tank; and
iii. convey the plastic material downstream of the first submersion agitator whereby the plastic material will re-float toward the surface of the separator liquid;
d) a plastics outlet disposed downstream from the first submersion agitator and toward the upper end of the tank and through which a separated plastic material stream comprising at least the plastic material is extractable from the tank; and
e) a metals outlet disposed toward the lower end of the tank and through which a separated metal stream comprising the precipitated metal material is extractable from the tank.

2. The apparatus of claim 1, wherein the first submersion agitator comprises a body portion that is rotatable about a first rotation axis that is generally parallel to the surface of the submersion liquid, and wherein the first engagement member is movable with the body portion about the first rotation axis.

3. The apparatus of claim 2, wherein the first engagement member comprises an axially extending base portion and a plurality of fingers extending laterally from the base portion, wherein the plurality of fingers are axially spaced apart from each other by gaps.

4. The apparatus of claim 3, wherein the fingers have respective finger widths in the axial direction that are between about 0.5 cm and about 5 cm.

5. The apparatus of claim 4, wherein the gaps have respective gap widths in the axial direction that are between about 0.5 cm and about 5 cm.

6. The apparatus of claim 2, wherein the first engagement member is offset from and extends substantially parallel to the first rotation axis.

7. The apparatus of claim 5, wherein the gaps widths are between 90% and 110% of the finger widths.

8. The apparatus of any one of claims 3 to 7, wherein the fingers are substantially planar and rectangular.

9. The apparatus of any one of claims 2 to 8, wherein the first submersion agitator further comprises a second engagement member that is movable with the body portion, spaced apart from and is arranged generally parallel to the first engagement member and that is configured to:
a) engage the metal and plastic materials floating at the surface of the separator liquid at the upstream side of the first submersion agitator;
b) urge the engaged metal and plastic materials downwardly to submerge them in the separator liquid thereby dislodging at least a second portion of metal material from the plastic material and allowing the dislodged second portion of the metal material to precipitate toward the lower end of the tank; and
c) convey the plastic material downstream of the first submersion agitator whereby the plastic material will re-float toward the surface of the separator liquid.

10. The apparatus of any one of claims 1 to 9, further comprising a second submersion agitator located between the first submersion agitator and the plastics outlet and comprising at least a first engagement member disposed proximate a surface of the separator liquid and that is movable and configured to:
i. engage the metal and plastic materials that have passed the first submersion agitator and are re-floating at the surface of the separator liquid at an upstream side of the second submersion agitator;
ii. urge the engaged metal and plastic materials downwardly to submerge them in the separator liquid thereby dislodging at least a first portion of metal material from the plastic material and allowing the dislodged first portion of the metal material to precipitate toward the lower end of the tank; and
iii. convey the plastic material downstream of the second submersion agitator whereby the plastic material will re-float toward the surface of the separator liquid.

11. The apparatus of claim 10, further comprising a third submersion agitator located between the second submersion agitator and the plastics outlet and comprising at least a first engagement member disposed proximate a surface of the separator liquid and that is movable and configured to:
i. engage the metal and plastic materials that have passed the first and the second submersion agitator and are re-floating at the surface of the separator liquid at an upstream side of the third submersion agitator;
ii. urge the engaged metal and plastic materials downwardly to submerge them in the separator liquid thereby dislodging at least a first portion of metal material from the plastic material and allowing the dislodged first portion of the metal material to precipitate toward the lower end of the tank; and
iii. convey the plastic material downstream of the second submersion agitator whereby the plastic material will re-float toward the surface of the separator liquid.

12. The apparatus of any one of claims 1 to 11, wherein the plastics outlet comprises a conveyor apparatus configured to engage the plastic material at the surface of the separator liquid and convey the plastic material out of the separator liquid.

13. The apparatus of claim 12, wherein the conveyor apparatus comprises at least a first inclined conveyor extending between a lower end submerged in the separator liquid and an upper end disposed above the surface of the separator liquid.

14. The apparatus of claim 12 or 13, wherein the conveyor apparatus is configured to convey the plastic material out of the tank.

15. The apparatus of any one of claims 1 to 14, wherein the metals outlet comprises an opening in the bottom of the tank that underlies at least the first submersion agitator, through with the precipitated metal material can pass.

16. The apparatus of claim 15, further comprising a metals conveyor configured to receive the precipitated metal material that passed thorough the opening in the bottom of the tank and convey the precipitated metal material away from the tank.

17. The apparatus of claim 16, wherein the metals conveyor comprises a submerged screw conveyor.

18. The apparatus of any one of claims 1 to 17, wherein the separator liquid comprises water and at least one of sodium hydroxide and calcium hydroxide.

19. The apparatus of claim 18, wherein the separator liquid is at an operating temperature that is less than 70 degrees C.
